(19) United States
(12) Patent Application Publication
(10) Pub. No.: US 2026/0313643 A1
(43) Pub. Date: Oct. 8, 2026

(54) TECHNOLOGIES FOR TRANSMISSIONS WITHOUT RETRANSMISSION

(71) Applicant: Apple Inc., Cupertino, CA (US)

(72) Inventors: Ping-Heng Kuo, London (GB); Fangli Xu, Beijing (CN); Naveen Kumar R. Palle Venkata, San Diego, CA (US); Peng Cheng, Beijing (CN); Ralf Rossbach, Munich (DE); Zhibin Wu, Los Altos, CA (US); Yuqin Chen, Beijing (CN); Haijing Hu, Los Gatos, CA (US); Alexander Sirotkin, Tel Aviv (IL); Sethuraman Gurumoorthy, San Ramon, CA (US)

(73) Assignee: Apple Inc., Cupertino, CA (US)

(21) Appl. No.: 19/481,152

(22) PCT Filed: May 5, 2023
(86) PCT No.: PCT/CN2023/092343

§ 371 Date: Nov. 3, 2025

(51) Int. Cl. H04W 72/1268; H04L 1/1812; H04L 5/00; H04W 72/563; H04W 76/20

(52) U.S. Cl. CPC H04W 72/1268; H04L 1/1812; H04L 5/0044; H04W 72/563; H04W 76/20

(57) ABSTRACT

The present application relates to devices and components, including apparatus, systems, and methods for starting or restarting a timer associated with a retransmission-less configured grant (CG).

### TECHNICAL FIELD

This application generally relates to cellular communication networks and, in particular, to technologies for uplink transmission without retransmission.

### BACKGROUND

Wireless cellular technology uses discontinuous reception (DRX) techniques to reduce the power consumption at a user equipment (UE). The UE may stop monitoring some downlink transmissions during the DRX OFF cycle and resume monitoring during the DRX ON cycle. Therefore, it is desired to keep the receiver path turned off during the DRX OFF cycle and reduce the interruptions that may cause the UE to turn on its receiver path during the DRX OFF cycles.

### BRIEF DESCRIPTION OF THE DRAWINGS

FIG. 1 illustrates a network environment in accordance with some embodiments

FIG. 2 illustrates a timing diagram in accordance with some embodiments

FIG. 3 illustrates an operational flow/algorithmic structure in accordance with some embodiments

FIG. 4 illustrates an operational flow/algorithmic structure in accordance with some embodiments

FIG. 5 illustrates an operational flow/algorithmic structure in accordance with some embodiments

FIG. 6 illustrates an operational flow/algorithmic structure in accordance with some embodiments

FIG. 7 illustrates an operational flow/algorithmic structure in accordance with some embodiments

FIG. 8 illustrates an operational flow/algorithmic structure in accordance with some embodiments

FIG. 9 illustrates a user equipment in accordance with some embodiments

FIG. 10 illustrates a network node in accordance with some embodiments

### DETAILED DESCRIPTION

The following detailed description refers to the accompanying drawings. The same reference numbers may be used in different drawings to identify the same or similar elements. In the following description, for purposes of explanation and not limitation, specific details are set forth, such as particular structures, architectures, interfaces, and/or techniques, in order to provide a thorough understanding of the various aspects of some embodiments. However, it will be apparent to those skilled in the art having the benefit of the present disclosure that the various aspects of the various aspects may be practiced in other examples that depart from these specific details. In certain instances, descriptions of well-known devices, circuits, and methods are omitted so as not to obscure the description of the various aspects with unnecessary detail. For the purposes of the present document, the phrase “A or B” means (A), (B), or (A and B), and the phrase “based on A” means “based at least in part on A,” for example, it could be “based solely on A,” or it could be “based in part on A.”

The following is a glossary of terms that may be used in this disclosure.

The term “circuitry” as used herein refers to, is part of, or includes hardware components, such as an electronic circuit, a logic circuit, a processor (shared, dedicated, or group), or memory (shared, dedicated, or group), an application specific integrated circuit (ASIC), a field-programmable device (FPD) (e.g., a field-programmable gate array (FPGA), a programmable logic device (PLD), a complex PLD (CPLD), a high-capacity PLD (HCPLD), a structured ASIC, or a programmable system-on-a-chip (SoC)), and/or digital signal processors (DSPs), that are configured to provide the described functionality. In some aspects, the circuitry may execute one or more software or firmware programs to provide at least some of the described functionality. The term “circuitry” may also refer to a combination of one or more hardware elements (or a combination of circuits used in an electrical or electronic system) with the program code used to carry out the functionality of that program code. In these aspects, the combination of hardware elements and program code may be referred to as a particular type of circuitry.

The term “processor circuitry” as used herein refers to, is part of, or includes circuitry capable of sequentially and automatically carrying out a sequence of arithmetic or logical operations; or recording, storing, or transferring digital data. The term “processor circuitry” may refer to an application processor; baseband processor; a central processing unit (CPU); a graphics processing unit; a single-core processor; a dual-core processor; a triple-core processor; a quad-core processor; or any other device capable of executing or otherwise operating computer-executable instructions, such as program code; software modules; or functional processes.

The term “interface circuitry,” as used herein, refers to, is part of, or includes circuitry that enables the exchange of information between two or more components or devices. The term “interface circuitry” may refer to one or more hardware interfaces; for example, buses, I/O interfaces, peripheral component interfaces, network interface cards, or the like.

The term “user equipment” or “UE” as used herein refers to a device with radio communication capabilities and may describe a remote user of network resources in a communications network. The term “user equipment” or “UE” may be considered synonymous to and may be referred to as client, mobile, mobile device, mobile terminal, user terminal, mobile unit, mobile station, mobile user, subscriber, user, remote station, access agent, user agent, receiver, radio equipment, reconfigurable radio equipment, reconfigurable mobile device, etc. Furthermore, the term “user equipment” or “UE” may include any type of wireless/wired device or any computing device, including a wireless communications interface.

The term “computer system,” as used herein, refers to any type of interconnected electronic devices, computer devices, or components thereof. Additionally, the term “computer system” or “system” may refer to various components of a computer that are communicatively coupled with one another. Furthermore, the term “computer system” or “system” may refer to multiple computer devices or multiple computing systems that are communicatively coupled with one another and configured to share computing or networking resources.

The term “resource” as used herein refers to a physical or virtual device, a physical or virtual component within a computing environment, or a physical or virtual component within a particular device, such as computer devices, mechanical devices, memory space, processor/CPU time, processor/CPU usage, processor and accelerator loads, hardware time or usage, electrical power, input/output operations, ports or network sockets, channel/link allocation, throughput, memory usage, storage, network, database and applications, workload units, or the like. A “hardware resource” may refer to a computer, storage, or network resources provided by physical hardware element(s). A “virtualized resource” may refer to a computer, storage, or network resources provided by virtualization infrastructure to an application, device, system, etc. The term “network resource” or “communication resource” may refer to resources that are accessible by computer devices/systems via a communications network. The term “system resources” may refer to any kind of shared entities to provide services and may include computing or network resources. System resources may be considered as a set of coherent functions, network data objects, or services accessible through a server where such system resources reside on a single host or multiple hosts and are clearly identifiable.

The term “channel,” as used herein, refers to any tangible or intangible transmission medium used to communicate data or a data stream. The term “channel” may be synonymous with or equivalent to “communications channel,” “data communications channel,” “transmission channel,” “data transmission channel,” “access channel,” “data access channel,” “link,” “data link,” “carrier,” “radio-frequency carrier,” or any other like term denoting a pathway or medium through which data is communicated. Additionally, the term “link,” as used herein, refers to a connection between two devices for the purpose of transmitting and receiving information.

The terms “instantiate,” “instantiation,” and the like, as used herein, refer to the creation of an instance. An “instance” also refers to a concrete occurrence of an object, which may occur, for example, during the execution of program code.

The term “connected” may mean that two or more elements at a common communication protocol layer have an established signaling relationship with one another over a communication channel, link, interface, or reference point.

The term “network element,” as used herein, refers to physical or virtualized equipment or infrastructure used to provide wired or wireless communication network services. The term “network element” may be considered synonymous with or referred to as a networked computer, networking hardware, network equipment, network node, virtualized network function, or the like.

The term “information element” refers to a structural element containing one or more fields. The term “field” refers to individual contents of an information element or a data element that contains content. An information element may include one or more additional information elements.

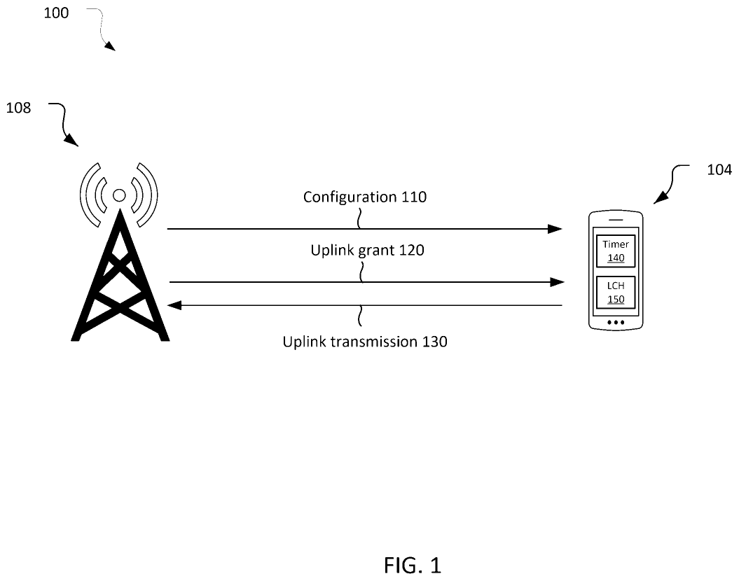

FIG. 1 illustrates a network environment 100 in accordance with some embodiments. The network environment 100 may include a UE 104 coupled with a base station (BS) 108 of a radio access network (RAN). In some embodiments, the BS 108 is a next-generation node B (gNB) that provides one or more 3GPP New Radio (NR) cells. In other embodiments, the BS 108 is an evolved node B (eNB) that provides one or more Long Term Evolution (LTE) cells. The air interface over which the UE 104 and the BS 108 communicate may be compatible with 3GPP technical specifications (TSs), such as those that define Fifth Generation (5G) NR or later system standards (e.g., Sixth Generation (6G) standards).

The BS 108 may send control information to the UEs in downlink control information (DCI) on a physical downlink control channel (PDCCH). The BS 108 may send control information directed to all the UEs in its network or may send dedicated control information directed to a specific UE, e.g., the UE 104. However, the UE 104 may not know its dedicated DCI's location, structure, or scrambling code. The UE 104, therefore, monitors the PDCCH to obtain common or dedicated DCIs. Monitoring the PDCCH is based on a trial and error method such as blind decoding.

The UE 104 may continuously monitor PDCCH even when the BS 108 does not send any data to the UE 104. The continuous monitoring of the PDCCH may consume a significant amount of power, reducing the battery life of the UE 104.

The BS 108 may configure the UE 104 with discontinuous reception (DRX). The DRX allows the UE 104 to periodically enter a DRX inactive mode during the DRX OFF duration or DRX OFF cycle. When in a DRX inactive mode, the UE 104 does not monitor PDCCH. The DRX OFF cycles are known to the BS 108, so the BS 108 may not send any information to the UE 104 during the UE's DRX OFF cycle. When the UE 104 is not in the DRX OFF cycle, it is in the DRX ON cycle or DRX active mode, during which the UE 104 may monitor PDCCH.

For new types of data traffic, such as extended reality (XR) data traffic, the UE 104 may need to send information to the BS 108 frequently. For example, the UE 104 may need to send pose information in uplink (UL) transmissions frequently. In the context of XR traffic, pose information refers to user pose and control updates on the UL, e.g., location or gesture.

Each UL transmission may be associated with a hybrid automatic repeat request (HARQ) process. For example, the BS 108 may send an UL grant 120 to the UE 104 indicating resources to be used for UL transmission, including a HARQ process identification (ID). If an UL transmission is not received by the BS 108, the BS 108 may request a retransmission. For example, the BS 108 may send another UL grant 120 to the UE 104, indicating that no new data should be transmitted, and include an indication of the HARQ process ID. Therefore, the UE 104 may need to monitor the PDCCH after each UL transmission in case of receiving a retransmission request from the BS 108.

In one instance, monitoring the PDCCH after an uplink transmission may overlap with the DRX OFF cycle and prevent the UE 104 from entering DRX inactive mode. When the UE 104 sends UL transmissions frequently, e.g., in the case of XR pose information, the UE 104 may not benefit from the power saving provided by entering DRX inactive mode during the DRX OFF cycle.

The BS 108 may configure the UE 104 with one or more timer 140 associated with the DRX. The BS 108 may use configuration 110 signaling to configure timers 140. In one instance, a timer of one or more timers 140 may track the DRX ON cycle. When this timer expires, the UE 104 may transition to DRX inactive mode. For example, drx-onDuration Timer tracks the DRX ON cycle during which the UE 104 stays active and may monitor PDCCH. If the UE 104 does not receive a PDCCH during DRX ON, it may transition to DRX inactive mode upon expiration of the drx-onDuration Timer. The UE 104 may stay in the DRX inactive mode until the next DRX ON duration starts.

When the UE 104 receives DCI on the PDCCH during the DRX ON cycle, the UE 104 may need to stay active for a possible UL or downlink (DL) transmission. The UE 104 may start a timer of one or more timers 140 to track the time during which the UE 104 stays active and monitors the PDCCH. In one instance, the UE 104 may not enter the DRX inactive mode as long as the active timer is running. For example, the drx-Inactivity Timer keeps the UE 104 in an active state after receiving a DCI. The UE 104 may stay in an active state and monitor PDCCH until the expiry of drx-InactivityTimer.

After an UL transmission, the UE 104, it may take some time for the BS 108 to process the UL transmission and send the retransmission request. In some instances, the time needed to receive, process, and respond to an UL (or a DL) transmission may be referred to as round trip time (RTT). During this time, the UE 104 may not expect to receive a DCI from the BS 108. The UE 104 may start a round trip timer of one or more timers 140 that tracks the time during which the UE 104 may not expect to receive a DCI from the BS 108 after an UL transmission. While the round trip timer is running, if the DRX ON timer (e.g., the drx-onDurationTimer) expires, the UE 104 may enter DRX inactive mode. Similarly, while the round trip timer is running, if the UE 104 is in DRX inactive mode, it may remain in that state. For example, the UE 104 may start a drx-HARQ-RTT-TimerUL timer after an UL transmission to track the round trip time. The UE 104 may expect to receive a retransmission request from the BS 108 after the expiration of the drx-HARQ-RTT-TimerUL. Therefore, if the UE 104 makes an UL transmission during the DRX OFF cycle, the UE 104 may remain in the DRX OFF cycle until the expiration of the drx-HARQ-RTT-TimerUL (or until the next DRX ON cycle start). Upon expiry of the drx-HARQ-RTT-TimerUL, if the UE 104 is still in the DRX OFF cycle, the UE 104 may interrupt the DRX OFF cycle and monitor the PDCCH for a potential retransmission request from the BS 108.

Once the round trip timer expires, the UE 104 may start monitoring the PDCCH for a potential retransmission request from the BS 108. Even if the UE 104 is at DRX inactive mode, upon expiration of the round trip timer, the UE 104 may transition to an active state and start monitoring the PDCCH. The UE 104 may start a retransmission timer of one or more timers 140 to track the time that the UE 104 should monitor PDCCH for a retransmission request associated with an UL transmission. For example, upon expiration of the drx-HARQ-RTT-TimerUL, the UE 104 may start the drx-RetransmissionTimerUL, which tracks the duration that the UE 104 is required to monitor the PDCCH. Upon expiration of the drx-Retransmission TimerUL, if the DRX OFF cycle (monitored by another timer) is not expired, the UE 104 may enter (or re-enter) the DRX inactive mode.

The UL traffic that needs to be transmitted regularly, such as XR pose updates, may require frequent UL scheduling and resource allocation. In one instance, the UE 104 may send a scheduling request for each UL transmission. In response to a scheduling request, the BS 108 would send an UL grant, e.g., by a dynamic UL grant, 120 to allocate resources for the UL transmission 130.

In another instance, the BS 108 may allocate resources for more than one UL transmission. In one instance, the BS 108 may allocate UL resources to be used by the UE 104 periodically for UL transmission. For example, the BS 108 may use configured grant (CG) scheduling for UL transmission 130, eliminating the need to schedule requests by the UE 104 and resource assignments by the BS 108 for each UL transmission 130. The BS 108 may send a configuration 110 message, e.g., CG, to the UE 104 to pre-allocate resources to the UE 104 for UL transmission 130. The configuration 110 may allocate one or more HARQ processes to a CG. The BS 108 may schedule regular UL traffic, such as XR pose updates, using CG.

Frequent UL transmission on CG resources may cause the UE 104 to interrupt the DRX OFF cycle and transition to active mode to monitor PDCCH for a potential retransmission request from the BS 108. Interrupting the DRX OFF cycle and transitioning to active mode increases the UE's power consumption and prevents the UE 104 from reaping the benefits of the DRX OFF cycle. To prevent interruption of the DRX OFF cycle, the BS 108 may configure the UE 104 with UL transmission in CG resource that does not require retransmission, even if the BS 108 (or any other network node) does not successfully receive the UL transmission.

In one instance, the BS 108 may send a configuration message 110 to the UE 104 to configure the UE 104 whether to start drx-HARQ-RTT-TimerUL or drx-Retransmission TimerUL. If the UE 104 does not start drx-RetransmissionTimerUL or the drx-HARQ-RTT-TimerUL, the DRX OFF cycle may not be interrupted and the UE 104 may not monitor the PDCCH for a possible retransmission request. In one instance, for UL transmission on a physical UL shared channel (PUSCH) that uses CG resources, the BS 108 may configure the UE 104 not to start drx-HARQ-RTT-TimerUL or the drx-RetransmissionTimerUL. As a result, the UE 104 may not monitor the PDCCH for retransmission. Therefore, the transmission associated with that HARQ process may no longer be retransmitted even in the event of unsuccessful UL transmission. The term “retransmission-less CG” (or CG without retransmission) can be referred to as a CG configuration wherein the drx-HARQ-RTT-TimerUL and/or the drx-Retransmission TimerUL are disabled for the PUSCHs of the CG configuration.

In one instance, to enable a retransmission-less CG, the BS 108 may configure a CG that does not start drx-HARQ-RTT-TimerUL or drx-RetransmissionTimerUL for UL transmission on PUSCH. The BS 108 may send a configuration 110 to configure the UE 104 with retransmission-less CG. The configuration 110 may explicitly or implicitly configure the UE 104 with retransmission-less CG. For example, when configuring a CG, the configuration 110 message may include a parameter in the CG configuration to indicate whether the UE should start drx-HARQ-RTT-TimerUL or drx-RetransmissionTimerUL with UL PUSCH transmissions on the corresponding CG. In this case, the retransmission-less CG is configured per CG configuration.

In another example, when configuring a CG, the configuration 110 may implicitly indicate that the configured CG is a retransmission-less CG. When configuring a CG, the configuration 110 may configure all HARQ processes associated with PUSCHs of the CG to operate in a specific HARQ process mode that does not support retransmission. In this case, the behavior of retransmission-less CG is configured per HARQ process (in contrast to per CG configuration). For example, HARQ Mode B, as described in 3GPP technical specifications (TS) and designed for non-terrestrial networks (NTN), is configured such that the UE should disable or stop round trip time and retransmission timers. HARQ Mode A may be used to allow retransmission. For example, when scheduled with HARQ Mode B, the UE 104 may stop the drx-RetransmissionTimerUL for the HARQ process for the first UL PUSCH transmission. An UL grant associated with a HARQ Mode B may be a retransmission-less UL grant. HARQ mode may be configured per the HARQ process via radio resource control (RRC) configuration.

Retransmission-less CG may be configured per CG configuration. A configuration message may configure a retransmission-less CG, and another configuration may configure a normal CG. The BS 108 may configure the UE 104 with both retransmission-less CG and normal CG. In one instance, the configuration signal 110 may be an RRC signaling configuring a retransmission-less CG.

A CG configuration may include multiple PUSCH resources, e.g., time and frequency resources. In addition, the CG configuration may be associated with a set of HARQ processes, and each PUSCH resource of the CG configuration is associated with a HARQ process from the set. In one example, HARQ process ID of each PUSCH is derived based on the formula described in 3GPP TSs. In another example, HARQ process ID of each PUSCH is selected by the UE. The CG configuration may include multiple CG PUSCH resources with the same or different HARQ process ID. The CG configuration may also include a timer of one or more timers 140. For example, the CG configuration may include a CG timer.

In one instance, the CG timer may be associated with the HARQ process ID(s) associated with the CG configuration. The UE 104 may start a CG timer with an UL PUSCH transmission whose HARQ process ID is associated with the CG. For example, the UE 104 may start the CG timer on the first orthogonal frequency-division multiplexing (OFDM) symbol of the UL PUSCH transmission. In another example, the UE 104 may start the CG timer after the completion of the UL PUSCH transmission, e.g., after the last OFDM symbol of the PUSCH. The CG timer may be associated with the HARQ process of the PUSCH resource used for the UL transmission.

In one instance, the UE 104 may receive an UL grant for an UL PUSCH transmission on the resources that are shared with a CG. In addition, the UL grant may also be associated with a HARQ ID that is the same as the HARQ ID of the CG. The UE may start the CG timer with the UL PUSCH transmission that is associated with the UL grant. The UL grant may be a dynamic grant (DG) associated with a DCI.

With the UL transmission, the transmitted packet is stored in a buffer associated with the corresponding HARQ process. A new transmission associated with the same HARQ process may result in replacing the HARQ buffer with the recently transmitted packet. Once the older packet is replaced with the newer packet in the HARQ buffer, the UE 104 may not respond to a retransmission request of the older packet. To protect the packet stored in the HARQ buffer while the CG timer associated with a HARQ process is running, the UE may not use CG resources with the same HARQ process for a new transmission.

In one instance, a DG may share the HARQ process with a retransmission-less CG. Starting or restarting the CG timer after UL transmission associated with the DG may be needed. The BS 108 may send a retransmission request (via a retransmission grant) to recover the UL transmission on the DG.

In one embodiment, the UL PUSCH transmission is associated with a retransmission-less CG. If the UE 104 starts the CG timer, new transmissions are blocked while the CG timer is running to protect the HARQ buffer for retransmission that may not be requested by the BS 108, e.g., when the UE is in DRX inactive mode where the UE does not even monitor DCI for potential retransmission grant. The unnecessary delay caused by the CG timer may increase the latency. The increased latency is undesirable for XR pose information with similar performance requirements as ultra-reliable low latency communications (URLLC).

The UE's packets may be buffered in logical channels (LCH). The UE 104 may have one or more LCH 150. The UE 104 performs a logical channel prioritization process (LCP) for creating medium access control (MAC) packet data unit (PDU). Each LCH may be configured with one or more LCP restrictions. For example, the LCP restriction may restrict including an LCH's packets in the MAC PDU. In one instance, an LCP restriction rule may define the set of CGs that can be used to transmit the MAC PDU. For example, the UE 104 may be configured with the allowedCG-List LCP restriction rule, which sets the allowed CGs for transmission. In one instance, an LCP restriction rule may define the HARQ mode that can be used to transmit the MAC PDU. For example, the UE 104 may be configured with the allowedHARQ-mode LCP restriction rule, which sets the allowed HARQ mode for transmission.

In one embodiment, a retransmission-less CG configuration may include HARQ mode, which means HARQ operation is disabled for all PUSCHs within this CG regardless of the HARQ process. However, if the configuration includes a HARQ mode that is restricted by the LCP restriction rule, the packets of the LCH mapped to this retransmission-less CG may be unreasonably blocked, causing undesired latency.

For a retransmission-less CG, the CG timer operation may be needed to make sure the MAC PDU of a DG sharing the same HARQ process with the retransmission-less CG can be protected from overwriting. However, running the CG timer may also impact performance as some CG resources may be unnecessarily blocked. Thus, embodiments describe how to enhance retransmission-less CG to ensure a MAC PDU transmitted by DG sharing the same HARQ process can be protected by the CG timer while reducing the impacts of latency caused by the CG timer.

An LCH may be configured to be allowed to use resources of a retransmission-less CG as well as the resources of a specific HARQ mode. For example, some resources of the retransmission-less CG may be configured with HARQ mode A and some with HARQ mode B. It may not be necessary to restrict the LCH from using the resources with HARQ mode A based on LCP restriction rules. Defining LCH mapping restrictions based on HARQ mode that prevents unnecessary restrictions for retransmission-less CG is desired.

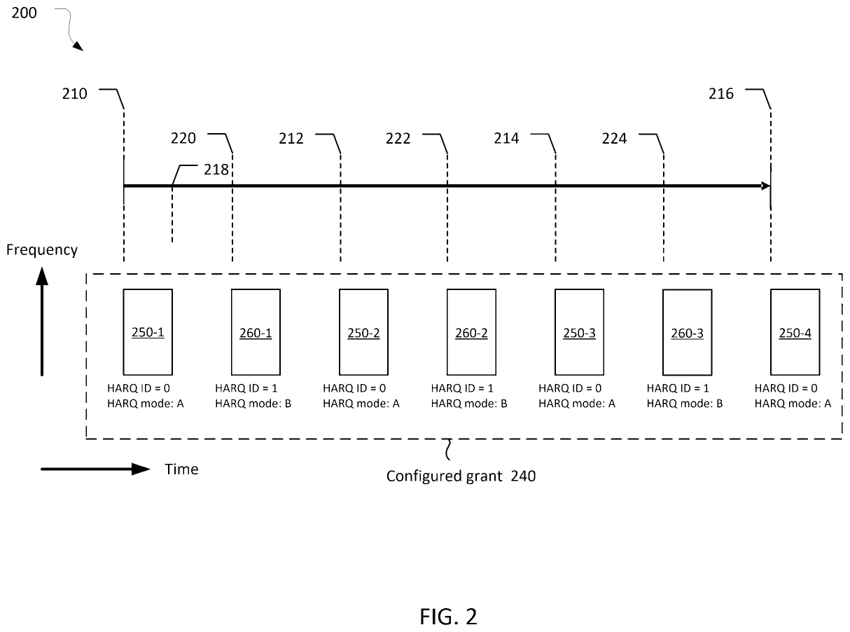

FIG. 2 illustrates a timing diagram 200 in accordance with some embodiments. The timing diagram 200 is an example of a CG 240. The CG 240 may include a plurality of CGs 250-1:4, collectively CGs 250, and 260-1:3, collectively CGs 260. The CGs 250 may include time and frequency resources for PUSCH transmissions that share the same HARQ ID, e.g., HARQ ID=0. The CGs 250 may share the same HARQ mode, e.g., HARQ Mode A. The CGs 260 may include time and frequency resources of a subset of CGs that share the same HARQ ID (HARQ ID=1). The CGs 260 may share the same HARQ mode, e.g., HARQ Mode B. The CGs 250 may have a different HARQ ID than the CGs 260.

In one embodiment, the UE may send a PUSCH transmission using within the CG 250-1. The transmitted packet is associated with the CG 250-1 HARQ process, e.g., HARQ ID=0 and HARQ Mode A, and may be stored in a HARQ buffer.

In a legacy system, the PUSCH transmission may trigger the UE may start a CG timer. The CG timer may be associated with the PUSCH transmission and with the HARQ process ID of the PUSCH transmission. For example, with PUSCH transmission on CG 250-1 at 210, the UE may start a CG timer at time mark 210 or any time between time mark 210 and 220. Where time mark 210 may be the time associated with the first OFDM symbol and 220 the time associated with the last OFDM symbol of the PUSCH transmission. The CG timer may be associated with the HARQ process ID of CG 250-1.

In a legacy system, while the CG timer associated with a HARQ process is running, the UE may not use CG resources associated with the same HARQ process ID. For example, consider a PUSCH transmission within CG 250-1. The PUSCH transmission may trigger the CG timer at 210. The CG timer may expire at 216. While the CG timer is running between 210 and 216, the UE may not use UL grants associated with the same HARQ ID as CG 250-1, e.g., HARQ ID=0. Therefore, CGs 250-2 and 250-3 may not be used for UL transmission because the CG timer is running, and CGs 250-2 and 250-3 have the same HARQ ID as CG 250-1. However, once the CG timer is expired at 216, CG 250-4 may be used for PUSCH transmission.

Even though the CG timer is running, the UE may use CGs 260 at 220, 222, or 224 time mark for UL transmission. Because the CGs 260 are associated with a HARQ process ID that differs from the HARQ process ID associated with the CG timer and CG 250-1. Consider that the UE sends an UL PUSCH transmission on CG 260-1 at time mark 220. The UE may start a second CG timer associated with CG 260-1 and its HARQ process ID. While the second timer is running, the UE may not use UL grant resources associated with the HARQ process ID associated with CG 260-2, i.e., HARQ process ID=1. Therefore, the UE may not send a PUSCH transmission associated with HARQ process ID=1 at CGs 260-2 or 260-3 at timer marks 222 and 224, respectively.

In one embodiment, the CG 240 may be a retransmission-less CG. The UE does not wake up from DRX inactive mode to monitor the potential retransmission grant for an UL PUSCH transmission, regardless of whether the destination has successfully received the transmitted PUSCH packet. Therefore, the UE may have a retransmission-less CG PUSCH transmission at 210 on CG 250-1 and another retransmission-less CG PUSCH transmission at 212 on CG 250-2.

The UE may receive an UL grant that shares resources with a retransmission-less CG 240. For example, the UE may receive a DG associated with the resources of CG 250-1, i.e., having the same time and frequency resources and the same HARQ process ID. Consider the UE sends a PUSCH associated with the DG. The DG may not be a retransmission-less grant and may need to keep the transmitted packet in the HARQ buffer. Further, consider a PUSCH transmission associated with the retransmission-less CG 250-2 or a PUSCH transmission associated with a DG that shares resources with CG 250-2. Such PUSCH transmission may overwrite the HARQ buffer, causing the loss of the PUSCH packet of the initial DG. The UE may utilize some timers to protect the HARQ buffer from being overwritten when the UE may expect a retransmission request from the BS.

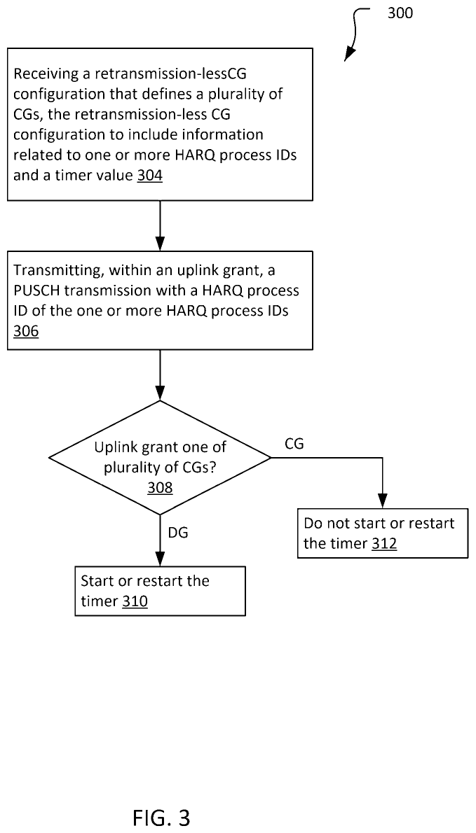

FIG. 3 illustrates an operational flow/algorithmic structure in accordance with some embodiments. Operational flow/algorithmic structure 300 is an example of operating a UE to start or restart a timer associated with a retransmission-less CG. The operational flow/algorithmic structure 300 may be implemented by a UE, for example, the UE 104, the UE 900, or components therein, e.g., processors 904.

The operational flow/algorithmic structure 300 may include, at 304, receiving a retransmission-less CG configuration that defines a plurality of CGs. For example, the plurality of CGs may include PUSCH resources allocated for UL transmission.

The retransmission-less CG configuration may include information relating to one or more HARQ process IDs. For example, a subset of the plurality of CGs may be associated with a HARQ process ID, and another subset of the plurality of CGs may be associated with another HARQ process ID.

The retransmission-less CG configuration may include a timer value. The timer value determines the time that a timer should run before expiring. In one instance, the timer value may be used to set a timer that counts down to zero, which would expire once the timer reaches zero. In another example, the timer starts from a zero value and expires once the timer reaches the time value.

The BS may send a configuration message to the UE to configure the retransmission-less CG. For example, the BS may use RRC signaling to configure the CG.

The retransmission-less CG may be associated with a sidelink. The sidelink may be used for direct UE to UE communications, with or without the assistance of the base station. In one embodiment, retransmission-less CG may be a CG where the UE does not start drx-Retransmission TimerSL or drx-HARQ-RTT-TimerSL with the corresponding sidelink transmission.

The operational flow/algorithmic structure 300 may include, at 306, transmitting, within an UL grant, a PUSCH transmission with a HARQ process ID of one or more HARQ process IDs. In one instance, “transmitting within an uplink grant” may include a transmission using the uplink resources associated with the uplink grant. In one instance, “a PUSCH transmission” may include an UL transmission using resources allocated to PUSCH. In one embodiment, the UL grant may be a DG. In one embodiment, the UL grant may be a CG. In one embodiment, the UL grant may be a retransmission-less CG.

The operational flow/algorithmic structure 300 may include, at 308, determining whether the UL grant is one of the plurality of CGs or determining whether the UL grant corresponds to a PUSCH pertaining to a retransmission-less CG configuration.

The operational flow/algorithmic structure 300 may include, at 310, determining to start or restart the timer with the timer value based on the determination at 308 that the UL grant is not one of the plurality of CGs (e.g., not a retransmission-less CG). In one embodiment, the UE may start or restart the timer when the UL grant is a DG, a CG of another CG configuration (different from the configured retransmission-less CG), or an UL grant received on a random access response.

In one embodiment, the timer is a CG retransmission timer. The UE may reset the CG retransmission timer after a successful PUSCH transmission. The UE may retransmit the MAC PDU after the expiration of the CG retransmission timer. For example, the CG retransmission timer may be cg-RetransmissionTimer as defined in 3GPP TSs.

In one embodiment, the timer is a small-data transmission (SDT) retransmission timer. The UE may retransmit the SDT packets upon expiration of the SDT retransmission timer. For example, the SDT retransmission timer may be a cg-SDT-Retransmission Timer.

The operational flow/algorithmic structure 300 may include, at 312, determining not to start or restart the timer with the timer value based on the determination at 308 that the UL grant is one of the plurality of CGs.

The UE may consider other conditions to determine whether to start or restart the timer, e.g., the CG timer, cg-RetransmitionTimer, or cg-SDT-RetransmissionTimer. For example, in one embodiment, the UE may start or restart the timer if the PUSCH transmission is during the DRX ON cycle (UE in DRX active state).

In one embodiment, if the uplink grant is a configured uplink grant: start or restart the configuredGrantTimer, if configured, for the corresponding HARQ process when the transmission is performed if listen-before-talk (LBT) failure indication is not received from lower layers and if the configured uplink grant is not configured as a “retransmission-less CG”; start or restart the cg-RetransmissionTimer, if configured, for the corresponding HARQ process when the transmission is performed if LBT failure indication is not received from lower layers. If the configured uplink grant is for the initial transmission for CG-SDT with CCCH message: start or restart the cg-SDT-RetransmissionTimer for the corresponding HARQ process when the transmission is performed. If the uplink grant is addressed to C-RNTI, and the identified HARQ process is configured for a configured uplink grant: start or restart the configuredGrantTimer, if configured, for the corresponding HARQ process when the transmission is performed if LBT failure indication is not received from lower layers.

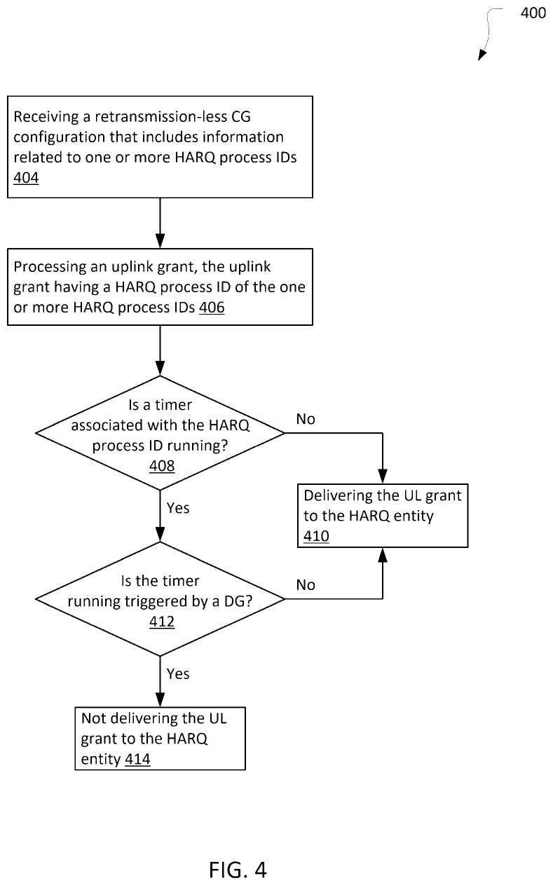

FIG. 4 illustrates an operational flow/algorithmic structure in accordance with some embodiments. Operational flow/algorithmic structure 400 is an example of operating a UE to start or restart a timer associated with a retransmission-less CG. The operational flow/algorithmic structure 400 may be implemented by a UE, for example, the UE 104, the UE 900, or components therein, e.g., processors 904.

The operational flow/algorithmic structure 400 may include, at 404, receiving a retransmission-less CG configuration that defines a plurality of CGs. For example, the plurality of CGs may include PUSCH resources allocated for UL transmission.

The retransmission-less CG configuration may include one or more HARQ process IDs. For example, a subset of the plurality of CGs may be associated with a HARQ process ID, and another subset of the plurality of CGs may be associated with another HARQ process ID.

The BS may send a configuration message to the UE to configure the retransmission-less CG. For example, the BS may use RRC signaling to configure the CG.

The retransmission-less CG may be associated with a sidelink. The sidelink may be used for direct UE to UE communications, with or without the assistance of the base station. In one embodiment, retransmission-less CG may be a CG where the UE does not start drx-Retransmission TimerSL or drx-HARQ-RTT-TimerSL with the corresponding sidelink transmission.

The operational flow/algorithmic structure 400 may include, at 406, processing an UL grant that has a HARQ process ID of the one or more HARQ process IDs of the configured retransmission-less CG. Processing the UL grant includes determining the allocated UL resources, such as the HARQ process and allocated time or frequency resources. The UE may receive the UL grant on a physical downlink control channel (PDCCH) or a physical downlink shared channel (PDSCH).

The operational flow/algorithmic structure 400 may include, at 408, determining that the timer associated with the HARQ process ID is running. In one embodiment, the timer may be a configured grant timer, a configured grant retransmission timer, or a configured grant small-data transmission retransmission timer.

In one embodiment, the operational flow/algorithmic structure 400 may include, at 408, determining a triggering event that started the timer. For example, the running of the timer may be triggered by a previous PUSCH transmission. The previous PUSCH transmission may be associated with a DG, a CG, or a retransmission-less CG with a different configuration than the configured retransmission-less CG in 404.

In case of determining, at 408, that the timer associated with the HARQ process ID is not running, the operational flow/algorithm structure may proceed to 410. The operational flow/algorithmic structure 400 may include, at 410, delivering the UL grant to the HARQ entity. The HARQ entity may be logical and includes transmission, reception, configuration, or operation related to a HARQ process. In some instances, delivering UL grant to a HARQ entity may include transmitting the PUSCH associated with the UL grant and delivering the transmitted packet to the HARQ buffer.

In case of determining, at 408, that the timer associated with the HARQ process ID is running, the operational flow/algorithm structure may proceed to 412. The operational flow/algorithmic structure 400 may include, at 412, determining whether the timer running is triggered because by a DG. In one embodiment, a timer running may be triggered by a PUSCH transmission associated with the DG. Alternatively, the UE may determine this by checking whether the packet stored in the HARQ buffer was prepared/generated for a DG.

In case of determining, at 412, that the timer running is not triggered by a DG (or a PUSCH transmission associated with the DG), the operational flow/algorithm structure may proceed to 410, described above.

In case of determining, at 412, that the running is triggered by a DG (or a PUSCH transmission associated with the DG), the operational flow/algorithm structure may proceed to 414. The operational flow/algorithmic structure 400 may include, at 414, not delivering (or suppressing the delivery of) the UL grant to the HARQ entity.

In one embodiment, the operational flow/algorithmic structure 400 may include, at 412, determining whether to deliver the UL grant to a HARQ entity based on the trigger event. For example, the UL grant may not be delivered to the HARQ entity when the UE does not perform the UL transmission associated with the UL grant.

In one embodiment, the UE may not deliver the UL grant to the HARQ entity when the triggering event is a PUSCH transmission associated with a DG. In one embodiment, the UE may not deliver the UL grant to the HARQ entity when the triggering event is a PUSCH transmission associated with any grant not associated with the configured retransmission-less CG at 404.

In one embodiment, the UE may deliver the UL grant to the HARQ entity when the triggering event is a PUSCH transmission associated with the configured retransmission-less CG at 404.

In one embodiment, if the UE is in DRX active state, the UE may refrain from delivering the UL grant to the HARQ entity, regardless of whether the timer was triggered by a CG or a DG. That is, the method described in FIG. 4 may only be applicable when the UE is in a DRX-inactive state.

In one embodiment, if, for the corresponding HARQ process, the configuredGrantTimer is not running and cg-RetransmissionTimer is not configured, and cg-SDT-RetransmissionTimer is not configured (i.e., new transmission), or; if, the configured uplink grant is a retransmission-less configured grant, and for the corresponding HARQ process, the configuredGrantTimer is running due to a PUSCH transmitted for an uplink grant that is not associated to the configured uplink grant: consider the new data indicator (NDI) bit for the corresponding HARQ process to have been toggled; deliver the configured uplink grant and the associated HARQ information to the HARQ entity.

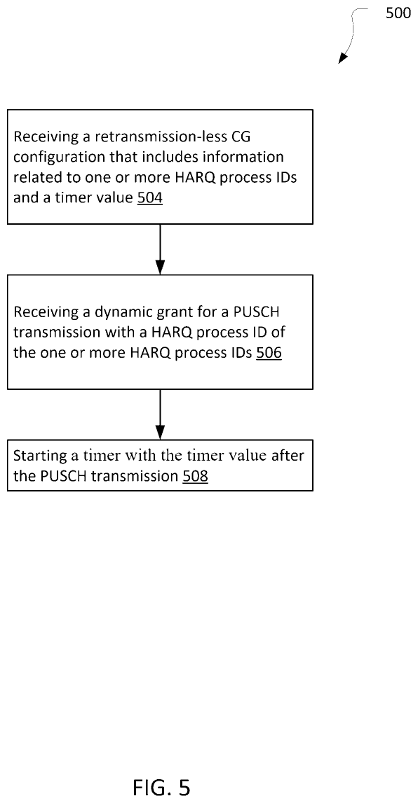

FIG. 5 illustrates an operational flow/algorithmic structure in accordance with some embodiments. Operational flow/algorithmic structure 500 is an example of operating a UE to start or restart a timer associated with a retransmission-less CG. The operational flow/algorithmic structure 500 may be implemented by a UE, for example, the UE 104, the UE 900, or components therein, e.g., processors 904.

The operational flow/algorithmic structure 500 may include, at 504, receiving a retransmission-less CG configuration that defines a plurality of CGs. For example, the plurality of CGs may include PUSCH resources allocated for UL transmission.

The retransmission-less CG configuration may include one or more HARQ process IDs. For example, a subset of the plurality of CGs may be associated with a HARQ process ID, and another subset of the plurality of CGs may be associated with another HARQ process ID.

The retransmission-less CG configuration may include a timer value. The timer value determines the time that a timer should run before expiring. In one instance, the timer value may be used to set a timer that counts down to zero, which would expire once the timer reaches zero. In another example, the timer starts from a zero value and expires once the timer reaches the time value.

The BS may send a configuration message to the UE to configure the retransmission-less CG. For example, the BS 108 may use RRC signaling to configure the CG.

The retransmission-less CG may be associated with a sidelink. The sidelink may be used for direct UE to UE communications, with or without the assistance of the base station. In one embodiment, retransmission-less CG may be a CG where the UE does not start drx-RetransmissionTimerSL or drx-HARQ-RTT-TimerSL with the corresponding sidelink transmission.

The operational flow/algorithmic structure 500 may include, at 506, receiving a DG for a PUSCH transmission with a HARQ process ID of the one or more HARQ process IDs of the configured retransmission-less CG.

The operational flow/algorithmic structure 500 may include, at 508, starting a timer with the timer value after the PUSCH transmission. The timer may be a dynamic grant timer, a configured grant retransmission timer, or a configured grant small-data transmission retransmission timer.

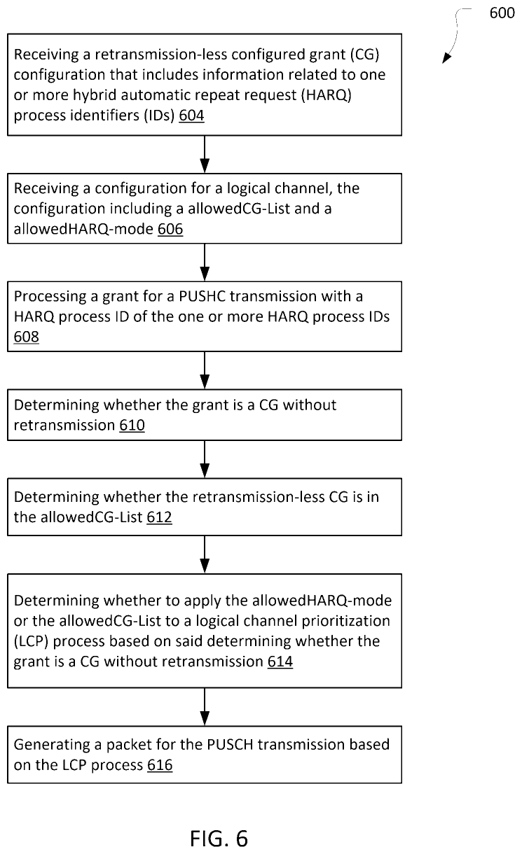

FIG. 6 illustrates an operational flow/algorithmic structure in accordance with some embodiments. Operational flow/algorithmic structure 600 is an example of operating a UE to start or restart a timer associated with a retransmission-less CG. The operational flow/algorithmic structure 600 may be implemented by a UE, for example, the UE 104, the UE 900, or components therein, e.g., processors 904.

The operational flow/algorithmic structure 600 may include, at 604, receiving a retransmission-less CG configuration that defines a plurality of CGs. For example, the plurality of CGs may include PUSCH resources allocated for UL transmission.

The retransmission-less CG configuration may include one or more HARQ process IDs. For example, a subset of the plurality of CGs may be associated with a HARQ process ID, and another subset of the plurality of CGs may be associated with another HARQ process ID.

The BS may send a configuration message to the UE to configure the retransmission-less CG. For example, the BS 108 may use RRC signaling to configure the CG.

The retransmission-less CG may be associated with a sidelink. The sidelink may be used for direct UE to UE communications, with or without the assistance of the base station. In one embodiment, retransmission-less CG may be a CG where the UE does not start drx-Retransmission TimerSL or drx-HARQ-RTT-TimerSL with the corresponding sidelink transmission.

The operational flow/algorithmic structure 600 may include, at 606, receiving a configuration for an LCH. The configuration may include LCP restriction rules, including an allowedCG-List and an allowedHARQ-mode. The allowedCG-List may indicate the CGs that may provide data for creating a MAC PDU. The allowedHARQ-mode may include the UL resources associated with HARQ mode(s) indicated by allowedHARQ-mode.

The operational flow/algorithmic structure 600 may include, at 608, processing an UL grant for a PUSCH transmission with a HARQ process ID of one or more HARQ process IDs.

The operational flow/algorithmic structure 600 may include, at 610, determining whether the UL grant is a CG without retransmission. In one embodiment, determining whether the UL grant is a CG without retransmission includes determining whether the UL grant is a DG, a retransmission-less CG, or a CG.

The operational flow/algorithmic structure 600 may include, at 612, determining whether the retransmission-less CG is in the allowedCG-List. When the retransmission-less CG is in the allowedCG-List, the LCP process may include the data of an LCH associated with the retransmission-less CG in the MAC PDU.

The operational flow/algorithmic structure 600 may include, at 614, determining whether to apply the allowedHARQ-mode or the allowedCG-List to an LCP process based on the determination at 610. In one embodiment, the LCP may ignore or suppress using allowedHARQ-mode restriction rule in the LCP process when the UL grant is a retransmission-less CG.

The operational flow/algorithmic structure 600 may include, at 616, generating a packet for the PUSCH transmission based on the LCP process.

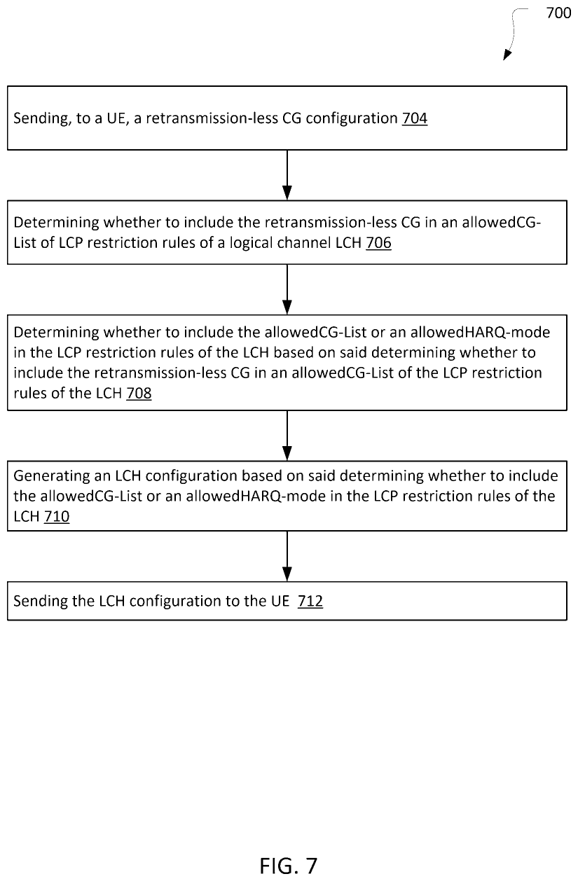

FIG. 7 illustrates an operational flow/algorithmic structure in accordance with some embodiments illustrates an operational flow/algorithmic 700 structure in accordance with some embodiments. Operational flow/algorithmic structure 700 is an example of operating a BS to provide LCP restriction rules associated with retransmission-less CG. The operational flow/algorithmic structure 700 may be implemented by a BS, for example, the BS 108, the BS 1000, or components therein, e.g., processors 1004.

The operational flow/algorithmic structure 700 may include, at 704, sending, to a user equipment (UE), a retransmission-less CG configuration. The BS may use RRC signaling for sending the retransmission-less CG configuration to the UE.

The operational flow/algorithmic structure 700 may include, at 706, determining whether to include the retransmission-less CG in an allowedCG-List of logical channel prioritization (LCP) restriction rules of a logical channel (LCH). The UE may only include the data from LCHs associated with CGs in the allowedCG-List in MAC PDU.

The operational flow/algorithmic structure 700 may include, at 708, determining whether to include the allowedCG-List or an allowedHARQ-mode in the LCP restriction rules of the LCH based on said determining whether to include the retransmission-less CG in an allowedCG-List of the LCP restriction rules of the LCH. The UE may include or exclude allowedCG-List or allowedHARQ-mode in the LCP restriction rules of the LCH based on whether the retransmission-less CG is included in the allowedCG-List.

In one embodiment, whether to include the allowedCG-List or an allowedHARQ-mode in the LCP restriction rules of the LCH includes: determining whether to include the retransmission-less CG in the allowedCG-List, determining whether to configure the LCH of the UE with the allowedCG-List, and determining not to configure the LCH of the UE with the allowedHARQ-mode.

In one embodiment, whether to include the allowedCG-List or an allowedHARQ-mode in the LCP restriction rules of the LCH includes: determining not to include the retransmission-less CG in the allowedCG-List, and determining whether to configure the LCH of the UE with the allowedHARQ-mode or the allowedCG-List.

The operational flow/algorithmic structure 700 may include, at 710, generating an LCH configuration based on said determining whether to include the allowedCG-List or an allowedHARQ-mode in the LCP restriction rules of the LCH.

The operational flow/algorithmic structure 700 may include, at 712, sending the LCH configuration to the UE based on said determining whether configuring the LCH of the UE with allowedCG-List or an allowedHARQ-mode. The base station may use RRC signaling for sending the LCH configuration to the UE. The BS may receive an UL PUSCH transmission based on the LCH configuration.

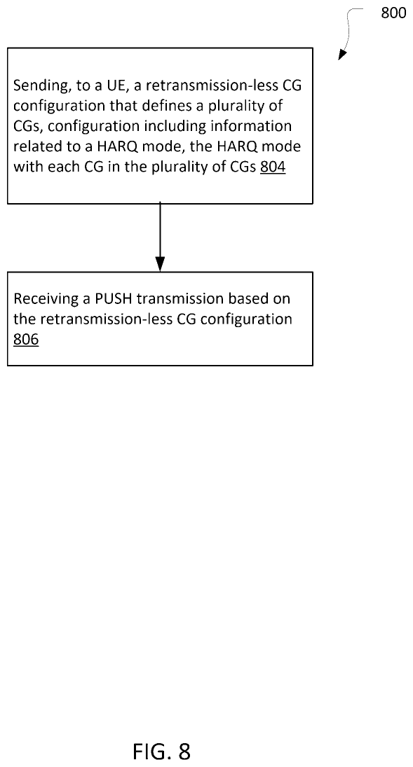

FIG. 8 illustrates an operational flow/algorithmic structure in accordance with some embodiments. Operational flow/algorithmic structure 800 is an example of operating a BS to associate all grants in a retransmission-less CG with the same HARQ mode. The operational flow/algorithmic structure 800 may be implemented by a BS, for example, the BS 108, the BS 1000, or components therein, e.g., processors 1004.

The operational flow/algorithmic structure 800 may include, at 804, sending, to a UE, a retransmission-less CG configuration that defines a plurality of CGs, the configuration including a HARQ mode, and the HARQ mode is associated with each CG in the plurality of CGs. In one example, the UE may configure the retransmission-less CG by sending an RRC message, including the retransmission-less CG configuration.

The operational flow/algorithmic structure 800 may include, at 806, receiving a physical uplink shared channel (PUSCH) transmission based on the retransmission-less CG configuration.

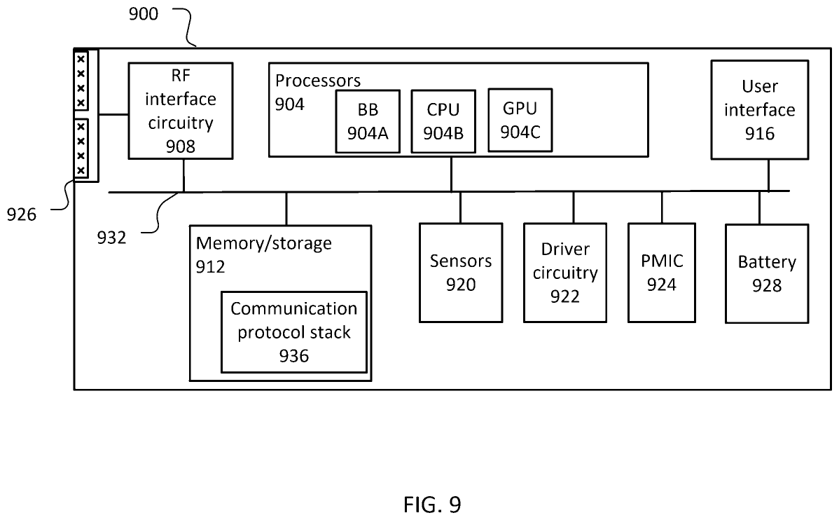

FIG. 9 illustrates a UE 900 in accordance with some embodiments. The UE 900 may be similar to and substantially interchangeable with UE 104 of FIG. 1.

The UE 900 may be any mobile or non-mobile computing device, such as, for example, a mobile phone, computer, tablet, XR device, glasses, industrial wireless sensor (for example, microphone, carbon dioxide sensor, pressure sensor, humidity sensor, thermometer, motion sensor, accelerometer, laser scanner, fluid level sensor, inventory sensor, electric voltage/current meter, or actuator), video surveillance/monitoring device (for example, camera or video camera), wearable device (for example, a smartwatch), or Internet-of-things device.

The UE 900 may include processors 904, RF interface circuitry 908, memory/storage 912, user interface 916, sensors 920, driver circuitry 922, power management integrated circuit (PMIC) 924, antenna structure 926, and battery 928. The components of the UE 900 may be implemented as integrated circuits (ICs), portions thereof, discrete electronic devices, or other modules, logic, hardware, software, firmware, or a combination thereof. The block diagram of FIG. 9 is intended to show a high-level view of some of the components of the UE 900. However, some of the components shown may be omitted, additional components may be present, and different arrangements of the components shown may occur in other implementations.

The components of the UE 900 may be coupled with various other components over one or more interconnects 932, which may represent any type of interface, input/output, bus (local, system, or expansion), transmission line, trace, or optical connection that allows various circuit components (on common or different chips or chipsets) to interact with one another.

The processors 904 may include processor circuitry such as, for example, baseband processor circuitry (BB) 904A, central processor unit circuitry (CPU) 904B, and graphics processor unit circuitry (GPU) 904C. The processors 904 may include any type of circuitry, or processor circuitry that executes or otherwise operates computer-executable instructions, such as program code, software modules, or functional processes from memory/storage 912 to cause the UE 900 to perform operations as described herein.

The processors 904 may perform operations associated with bearer flows as described elsewhere herein. For example, the processors 904 may start or restart a timer associated with a retransmission-less CG or configure an LCH's LCP restriction rules consistent with the embodiments described herein.

In some embodiments, the baseband processor circuitry 904A may access a communication protocol stack 936 in the memory/storage 912 to communicate over a 3GPP-compatible network. In general, the baseband processor circuitry 904A may access the communication protocol stack 936 to: perform user plane functions at a PHY layer, MAC layer, RLC sublayer, PDCP sublayer, SDAP sublayer, and upper layer; and perform control plane functions at a PHY layer, MAC layer, RLC sublayer, PDCP sublayer, RRC layer, and a NAS layer. In some embodiments, the PHY layer operations may additionally/alternatively be performed by the components of the RF interface circuitry 908.

The baseband processor circuitry 904A may generate or process baseband signals or waveforms that carry information in 3GPP-compatible networks. In some embodiments, the waveforms for NR may be based on the cyclic prefix OFDM (CP-OFDM) in the uplink or downlink and discrete Fourier transform spread OFDM (DFT-S-OFDM) in the uplink.

The memory/storage 912 may include one or more non-transitory, computer-readable media that includes instructions (for example, the communication protocol stack 936) that may be executed by one or more of the processors 904 to cause the UE 900 to perform various operations described herein. The memory/storage 912 includes any type of volatile or non-volatile memory that may be distributed throughout the UE 900. In some embodiments, some of the memory/storage 912 may be located on the processors 904 themselves (for example, L1 and L2 cache), while other memory/storage 912 is external to the processors 904 but accessible thereto via a memory interface. The memory/storage 912 may include any suitable volatile or non-volatile memory such as, but not limited to, dynamic random access memory (DRAM), static random access memory (SRAM), erasable programmable read-only memory (EPROM), electrically erasable programmable read-only memory (EEPROM), Flash memory, solid-state memory, or any other type of memory device technology.

The RF interface circuitry 908 may include transceiver circuitry and a radio frequency front module (RFEM) that allows the UE 900 to communicate with other devices over a radio access network. The RF interface circuitry 908 may include various elements arranged in transmit or receive paths. These elements may include, for example, switches, mixers, amplifiers, filters, synthesizer circuitry, and control circuitry.

In the receive path, the RFEM may receive a radiated signal from an air interface via antenna structure 926 and proceed to filter and amplify (with a low-noise amplifier) the signal. The signal may be provided to a receiver of the transceiver that down-converts the RF signal into a baseband signal that is provided to the baseband processor of the processor 904.

In the transmit path, the transmitter of the transceiver up-converts the baseband signal received from the baseband processor and provides the RF signal to the RFEM. The RFEM may amplify the RF signal through a power amplifier prior to the signal being radiated across the air interface via the antenna 926.

In various embodiments, the RF interface circuitry 908 may be configured to transmit/receive signals in a manner compatible with NR access technologies.

The antenna 926 may include antenna elements to convert electrical signals into radio waves to travel through the air and to convert received radio waves into electrical signals. The antenna elements may be arranged into one or more antenna panels. The antenna 926 may have antenna panels that are omnidirectional, directional, or a combination thereof to enable beamforming and multiple input, multiple output communications. The antenna 926 may include microstrip antennas, printed antennas fabricated on the surface of one or more printed circuit boards, patch antennas, or phased array antennas. The antenna 926 may have one or more panels designed for specific frequency bands, including bands in FR1 or FR2.

The user interface circuitry 916 includes various input/output (I/O) devices designed to enable user interaction with the UE 900. The user interface 916 includes input device circuitry and output device circuitry. Input device circuitry includes any physical or virtual means for accepting an input, including, inter alia, one or more physical or virtual buttons (for example, a reset button), a physical keyboard, keypad, mouse, touchpad, touchscreen, microphones, scanner, headset, or the like. The output device circuitry includes any physical or virtual means for showing information or otherwise conveying information, such as sensor readings, actuator position(s), or other like information. Output device circuitry may include any number or combinations of audio or visual displays, including, inter alia, one or more simple visual outputs/indicators (for example, binary status indicators such as light emitting diodes (LEDs) and multi-character visual outputs, or more complex outputs such as display devices or touchscreens (for example, liquid crystal displays (LCDs), LED displays, quantum dot displays, and projectors), with the output of characters, graphics, multimedia objects, and the like being generated or produced from the operation of the UE 900.

The sensors 920 may include devices, modules, or subsystems whose purpose is to detect events or changes in its environment and send the information (sensor data) about the detected events to some other device, module, or subsystem. Examples of such sensors include inertia measurement units comprising accelerometers, gyroscopes, or magnetometers; microelectromechanical systems or nanoelectromechanical systems comprising 3-axis accelerometers, 3-axis gyroscopes, or magnetometers; level sensors; flow sensors; temperature sensors (for example, thermistors); pressure sensors; barometric pressure sensors; gravimeters; altimeters; image capture devices (for example, cameras or lensless apertures); light detection and ranging sensors; proximity sensors (for example, infrared radiation detector and the like); depth sensors; ambient light sensors; ultrasonic transceivers; and microphones or other like audio capture devices.

The driver circuitry 922 may include software and hardware elements that operate to control particular devices that are embedded in the UE 900, attached to the UE 900, or otherwise communicatively coupled with the UE 900. The driver circuitry 922 may include individual drivers allowing other components to interact with or control various I/O devices that may be present within or connected to the UE 900. For example, the driver circuitry 922 may include circuitry to facilitate the coupling of a universal integrated circuit card (UICC) or a universal subscriber identity module (USIM) to the UE 900. For additional examples, driver circuitry 922 may include a display driver to control and allow access to a display device, a touchscreen driver to control and allow access to a touchscreen interface, sensor drivers to obtain sensor readings of sensor circuitry 920 and control and allow access to sensor circuitry 920, drivers to obtain actuator positions of electro-mechanic components or control and allow access to the electro-mechanic components, a camera driver to control and allow access to an embedded image capture device, audio drivers to control and allow access to one or more audio devices.

The PMIC 924 may manage the power provided to various components of the UE 900. In particular, with respect to the processors 904, the PMIC 924 may control power-source selection, voltage scaling, battery charging, or DC-to-DC conversion.

In some embodiments, the PMIC 924 may control or otherwise be part of various power-saving mechanisms of the UE 900, including DRX, as discussed herein.

A battery 928 may power the UE 900, although in some examples, the UE 900 may be mounted and deployed in a fixed location and may have a power supply coupled to an electrical grid. The battery 928 may be a lithium-ion battery, a metal-air battery, such as a zinc-air battery, an aluminum-air battery, a lithium-air battery, and the like. In some implementations, such as in vehicle-based applications, the battery 928 may be a typical lead-acid automotive battery.

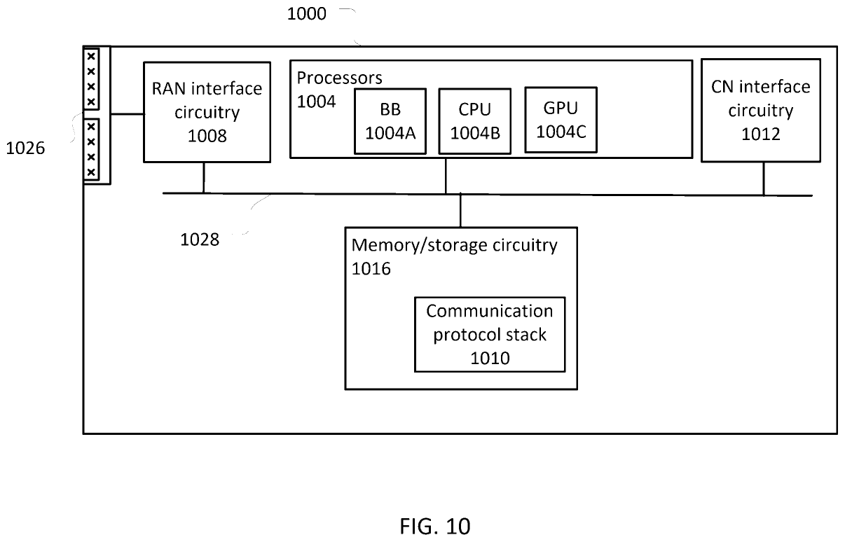

FIG. 10 illustrates a network node 1000 in accordance with some embodiments. The network node 1000 may be similar to and substantially interchangeable with base station 108, a device implementing one of the network hops, an integrated access and backhaul (IAB) node, a network-controlled repeater, or a server in a core network or external data network.

The network node 1000 may include processors 1004, RF interface circuitry 1008 (if implemented as an access node), the core node (CN) interface circuitry 1012, memory/storage circuitry 1016, and antenna structure 1026.

The components of the network node 1000 may be coupled with various other components over one or more interconnects 1028.

The processors 1004, RF interface circuitry 1008, memory/storage circuitry 1016 (including communication protocol stack 1010), antenna structure 1026, and interconnects 1028 may be similar to like-named elements shown and described with respect to FIG. 9.

The processors 1004 may perform operations associated with bearer flows as described elsewhere herein. For example, the processors 1004 may start or restart a timer associated with a retransmission-less CG or configure an LCH's LCP restriction rules consistent with the embodiments described herein.

The CN interface circuitry 1012 may provide connectivity to a core network, for example, a 5th Generation Core network (5GC) using a 5GC-compatible network interface protocol such as carrier Ethernet protocols or some other suitable protocol. Network connectivity may be provided to/from the network node 1000 via a fiber optic or wireless backhaul. The CN interface circuitry 1012 may include one or more dedicated processors or FPGAs to communicate using one or more of the aforementioned protocols. In some implementations, the CN interface circuitry 1012 may include multiple controllers to provide connectivity to other networks using the same or different protocols.

In some embodiments, the network node 1000 may be coupled with transmit-receive points (TRPs) using the antenna structure 1026, CN interface circuitry, or other interface circuitry.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

For one or more aspects, at least one of the components set forth in one or more of the preceding figures may be configured to perform one or more operations, techniques, processes, or methods as set forth in the example section below. For example, the baseband circuitry, as described above in connection with one or more of the preceding figures, may be configured to operate in accordance with one or more of the examples set forth below. For another example, circuitry associated with a UE, base station, network element, etc., as described above in connection with one or more of the preceding figures, may be configured to operate in accordance with one or more of the examples set forth below in the example section.

### EXAMPLES

In the following sections, further exemplary aspects are provided.
Example 1 includes the method of operating a user equipment (UE), the method comprising: receiving a retransmission-less configured grant (CG) configuration that defines a plurality of CGs, the retransmission-less CG configuration to include one or more hybrid automatic repeat request (HARQ) process identifiers (IDs) and a timer value; transmitting, within an uplink grant, a physical uplink shared channel (PUSCH) transmission with a HARQ process ID of the one or more HARQ process IDs; determining whether the uplink grant is one of the plurality of CGs; and determining whether to start a timer with the timer value based on said determining whether the uplink grant is one of the plurality of CGs, wherein the timer is a CG retransmission timer or a CG small-data transmission (SDT) retransmission timer.
Example 2 includes the method of example 1 or some other examples herein, wherein said determining whether the uplink grant is one of the plurality of CGs comprises determining the uplink grant is one of the plurality of CGs and said determining whether to start the timer comprises determining not to start the timer based on said determining that the uplink grant is one of the plurality of CGs.
Example 3 includes the method of examples 1 or 2 or some other examples herein, wherein said determining whether the uplink grant is one of the plurality of CGs comprises determining the uplink grant is not one of the plurality of CGs and said determining whether to start the timer comprises determining to start the timer based on said determining that the uplink grant is not one of the plurality of CGs.
Example 4 includes a method of operating a user equipment (UE), the method comprising: receiving a retransmission-less configured grant (CG) configuration that includes one or more hybrid automatic repeat request (HARQ) process identifiers (IDs); processing an uplink grant, the uplink grant having a HARQ process ID of the one or more HARQ process IDs; determining a timer associated with the HARQ process ID is running; determining a trigger event that started the timer; and determining whether to deliver the uplink grant to a HARQ entity based on the trigger event.
Example 5 includes the method of examples 4 or some other examples herein, wherein the timer is a configured grant timer, a configured grant retransmission timer, or a configured grant small-data transmission retransmission timer.
Example 6 includes the method of examples 4 or 5 or some other examples herein, wherein the trigger event is a physical uplink shared channel (PUSCH) transmission associated with a dynamic grant and said determining whether to deliver the uplink grant to a HARQ entity comprises: determining not to deliver the uplink grant to the HARQ entity.
Example 7 includes the method of any of examples 4-6 or some other examples herein, wherein the uplink grant is a dynamic grant and the method further comprises: receiving the uplink grant, from a base station, on a physical downlink control channel (PDCCH) or a physical downlink shared channel (PDSCH).
Example 8 includes the method of any of examples 4-7 or some other examples herein, wherein the trigger event is a physical uplink shared channel (PUSCH) transmission associated with a CG and said determining whether to deliver the uplink grant to a HARQ entity comprises determining to deliver the uplink grant to the HARQ entity.
Example 9 includes the method of any of examples 4-8 or some other examples herein, further comprising: delivering the uplink grant to the HARQ entity; and restarting the timer based on a physical uplink shared channel (PUSCH) transmission associated with the uplink grant.
Example 10 includes a method of operating a user equipment (UE), the method comprising: receiving a retransmission-less configured grant (CG) configuration that includes one or more hybrid automatic repeat request (HARQ) process identifiers (IDs) and a timer value; receiving a dynamic grant for a physical uplink shared channel (PUSCH) transmission with a HARQ process ID of the one or more HARQ process IDs; and starting a timer with the timer value after the PUSCH transmission.
Example 11 includes the method of example 10 or some other examples herein, wherein the timer is a dynamic grant timer, a configured grant retransmission timer, or a configured grant small-data transmission retransmission timer.
Example 12 includes the method of examples 10 or 11 or some other examples herein, wherein said receiving a retransmission-less CG configuration comprises receiving a radio resource control (RRC) message, including the retransmission-less CG configuration.
Example 13 includes the method of any of examples 10-12 or some other examples herein, the method comprising: receiving a retransmission-less configured grant (CG) configuration that includes one or more hybrid automatic repeat request (HARQ) process identifiers (IDs); receiving a configuration for a logical channel, the configuration including a allowedCG-List and a allowedHARQ-mode; processing an uplink (UL) grant for a physical uplink shared channel (PUSCH) transmission with a HARQ process ID of the one or more HARQ process IDs; determining whether the grant is a CG without retransmission; determining whether the retransmission-less CG is in the allowedCG-List; determining whether to apply the allowedHARQ-mode or the allowedCG-List to a logical channel prioritization (LCP) process based on said determining whether the grant is a CG without retransmission; and generating a packet for the PUSCH transmission based on the LCP process.
Example 14 includes the method of any of examples 10-13 or some other examples herein, wherein said determining whether the UL grant is a CG without retransmission comprises determining whether the UL grant is a dynamic grant, a retransmission-less CG, or a CG with retransmission.
Example 15 includes the method of any of examples 10-14 or some other examples herein, wherein said determining whether to apply allowedHARQ-mode or allowedCG-List to a LCP process based on said determining whether the grant is a CG without retransmission comprises: determining the UL grant is a retransmission-less CG; applying the allowedCG-List to the LCP process; and suppressing an application of the allowedHARQ-mode to the LCP process.
Example 16 includes a method of operating a base station (BA), the method comprising: sending, to a user equipment (UE), a retransmission-less configured grant (CG) configuration; determining whether to include the retransmission-less CG in an allowedCG-List of logical channel prioritization (LCP) restriction rules of a logical channel (LCH); determining whether to include the allowedCG-List or an allowedHARQ-mode in the LCP restriction rules of the LCH based on said determining whether to include the retransmission-less CG in an allowedCG-List of the LCP restriction rules of the LCH; generating an LCH configuration based on said determining whether to include the allowedCG-List or an allowedHARQ-mode in the LCP restriction rules of the LCH; and sending the LCH configuration to the UE.
Example 17 includes the method of example 16 or any other examples herein, wherein said determining whether configuring a UE with an allowedCG-List or an allowedHARQ-mode comprises: determining to include the retransmission-less CG in the allowedCG-List; determining to configure the LCH of the UE with the allowedCG-List; and determining not to configure the LCH of the UE with the allowedHARQ-mode.
Example 18 includes the method of examples 16 or 17 or any other examples herein, wherein said sending a configuration to the UE comprises sending a radio resource control (RRC) message, including the retransmission-less CG configuration.
Example 19 includes a method of operating a base station (BA), the method comprising: sending, to a user equipment (UE), a retransmission-less configured grant (CG) configuration that defines a plurality of CGs, configuration including a hybrid automatic repeat request (HARQ) mode, the HARQ mode associated with each CG in the plurality of CGs; and receiving a physical uplink shared channel (PUSH) transmission based on the retransmission-less CG configuration.
Example 20 includes the method of example 19 or any other examples herein, wherein said sending, to a UE, a retransmission-less CG configuration comprises sending a radio resource control (RRC) message including the retransmission-less CG configuration.

Another example may include an apparatus comprising logic, modules, or circuitry to perform one or more elements of a method described in or related to any of examples 1-20 or any other method or process described herein.

Another example may include a method, technique, or process as described in or related to any of examples 1-20 or portions or parts thereof.

Another example may include an apparatus comprising: one or more processors and one or more computer-readable media comprising instructions that, when executed by one or more processors, cause the one or more processors to perform the method, techniques, or process as described in or related to any of examples 1-20, or portions thereof.

Another example includes a signal as described in or related to any of examples 1-20, or portions or parts thereof.

Another example may include a datagram, information element, packet, frame, segment, PDU, or message as described in or related to any of examples 1-20, or portions or parts thereof, or otherwise described in the present disclosure.

Another example may include a signal encoded with data as described in or related to any of examples 1-20, or portions or parts thereof, or otherwise described in the present disclosure.

Another example may include a signal encoded with a datagram, IE, packet, frame, segment, PDU, or message as described in or related to any of examples 1-20, or portions or parts thereof, or otherwise described in the present disclosure.

Another example may include an electromagnetic signal carrying computer-readable instructions, wherein execution of the computer-readable instructions by one or more processors is to cause the one or more processors to perform the method, techniques, or process as described in or related to any of examples 1-20, or portions thereof.

Another example may include a computer program comprising instructions, wherein execution of the program by a processing element is to cause the processing element to carry out the method, techniques, or process as described in or related to any of examples 1-20 or portions thereof.

Another example may include a signal in a wireless network, as shown and described herein.

Another example may include a method of communicating in a wireless network, as shown and described herein.

Another example may include a system for providing wireless communication, as shown and described herein.

Another example may include a device for providing wireless communication, as shown and described herein.

Any of the above-described examples may be combined with any other example (or combination of examples), unless explicitly stated otherwise. The foregoing description of one or more implementations provides illustration and description but is not intended to be exhaustive or to limit the scope of aspects to the precise form disclosed. Modifications and variations are possible in light of the above teachings or may be acquired from the practice of various aspects.

Although the aspects above have been described in considerable detail, numerous variations and modifications will become apparent to those skilled in the art once the above disclosure is fully appreciated. It is intended that the following claims be interpreted to embrace all such variations and modifications.

1.-20. (canceled)

21. A method comprising:
receiving a retransmission-less configured grant (CG) configuration that indicates a plurality of CGs, the retransmission-less CG configuration to include information relating to at least one hybrid automatic repeat request (HARQ) process identifier (ID) and a timer value;
generating, for transmission, a physical uplink shared channel (PUSCH) transmission corresponding to an uplink grant with a HARQ process ID of the at least one HARQ process ID;
determining whether the uplink grant is one of the plurality of CGs; and
determining whether to start a timer with the timer value based on said determining whether the uplink grant is one of the plurality of CGs, wherein the timer is a CG retransmission timer or a CG small-data transmission (SDT) retransmission timer.

22. The method of claim 21, wherein said determining whether the uplink grant is one of the plurality of CGs comprises determining the uplink grant is one of the plurality of CGs and said determining whether to start the timer comprises determining not to start the timer based on said determining that the uplink grant is one of the plurality of CGs.

23. The method of claim 21, wherein said determining whether the uplink grant is one of the plurality of CGs comprises determining the uplink grant is not one of the plurality of CGs and said determining whether to start the timer comprises determining to start the timer based on said determining that the uplink grant is not one of the plurality of CGs.

24. The method of claim 21, wherein the timer is a first timer, and wherein the method further comprises:
identifying that a second timer associated with the HARQ process ID is running;
identifying a trigger event that started the second timer;
determining whether to deliver the uplink grant to a HARQ entity based on the trigger event; and
processing the uplink grant based on said determining whether to deliver the uplink grant to the HARQ entity.

25. The method of claim 24, wherein the second timer is a configured grant timer, a configured grant retransmission timer, or a configured grant small-data transmission retransmission timer.

26. The method of claim 24, wherein the trigger event is another PUSCH transmission associated with a dynamic grant and said determining whether to deliver the uplink grant to a HARQ entity comprises:
determining not to deliver the uplink grant to the HARQ entity.

27. The method of claim 24, wherein the uplink grant is a dynamic grant and the method further comprises:
receiving the uplink grant, from a base station, on a physical downlink control channel (PDCCH) or a physical downlink shared channel (PDSCH).

28. The method of claim 24, wherein the trigger event is a CG PUSCH transmission and said determining whether to deliver the uplink grant to a HARQ entity comprises determining to deliver the uplink grant to the HARQ entity.

29. The method of claim 28, further comprising:
delivering the uplink grant to the HARQ entity; and
restarting the timer based on the PUSCH transmission associated with the uplink grant.

30. The method of claim 21, further comprising starting the timer with the timer value based on transmission of the PUSCH transmission.

31. The method of claim 30, wherein the timer is a dynamic grant timer, a configured grant retransmission timer, or a configured grant small-data transmission retransmission timer.

32. An apparatus comprising:
processor circuitry to:
receive a retransmission-less configured grant (CG) configuration that includes a hybrid automatic repeat request (HARQ) process identifier (ID);
receive a configuration for a logical channel, the configuration including an allowed CG list and an allowed HARQ mode;
process an uplink (UL) grant for a physical uplink shared channel (PUSCH) transmission with the HARQ process ID;
determine whether the grant is a CG without retransmission;
determine whether to apply the allowed HARQ mode or the allowed CG list to a logical channel prioritization (LCP) process based on said detether determination of whether the grant is a CG without retransmission; and
output a packet for the PUSCH transmission based on the LCP process; and
interface circuitry coupled to the processor circuitry to transmit the PUSCH transmission.

33. The apparatus of claim 32, wherein to determine whether the UL grant is a CG without retransmission comprises to determine whether the UL grant is a dynamic grant, a retransmission-less CG, or a CG with retransmission.

34. The apparatus of claim 32, wherein to determine whether to apply allowedHARQ-mode or allowedCG-List to a LCP process based on the determination of whether the grant is a CG without retransmission comprises to:
determine the UL grant is a retransmission-less CG;
apply the allowedCG-List to the LCP process; and
suppress an application of the allowedHARQ-mode to the LCP process.

35. The apparatus of claim 32, wherein the processor circuitry is further to determine whether the retransmission-less CG is in the allowed CG list, and wherein to determine whether to apply the allowed HARQ mode or the allowed CG list to the LCP process is further based on the determination of whether the retransmission-less CG is in the allowed CG list.

36. A method comprising:
generating, for transmission to a user equipment (UE), configuration information to configure a retransmission-less configured grant (CG);
determining whether to include the retransmission-less CG in an allowed CG list of logical channel prioritization (LCP) restriction rules of a logical channel (LCH);
determining whether to include the allowed CG list or an allowed hybrid automatic repeat request (HARQ) mode in the LCP restriction rules of the LCH based on said determining whether to include the retransmission-less CG in the allowed CG list of the LCP restriction rules of the LCH;
generating, for transmission to the UE, an LCH configuration based on said determining whether to include the allowed CG list or the allowed HARQ mode in the LCP restriction rules of the LCH.

37. The method of claim 36,
wherein determining whether to include the retransmission-less CG in an allowed CG list includes determining to include the retransmission-less CG in the allowed CG list; and
wherein the LCH configuration is to configure the LCH of the UE with the allowed CG list and does not configure the LCH of the UE with the allowed HARQ mode.

38. The method of claim 36, wherein said sending a configuration to the UE comprises sending a radio resource control (RRC) message including the retransmission-less CG configuration.

39. The method of claim 36, wherein the configuration information is to configure a plurality of retransmission-less CGs, wherein the configuration information includes a HARQ mode associated with each CG in the plurality of CGs; and
receiving a physical uplink shared channel (PUSCH) transmission from the UE based on the configuration information.

40. The method of claim 39, wherein the configuration information is transmitted in a radio resource control (RRC) message.
